(19) United States
(12) Patent Application Publication
(10) Pub. No.: US 2025/0320394 A1
(43) Pub. Date: Oct. 16, 2025

(54) Form-Stabilized Eutectoid Salt Hydrate Phase Change Materials That Store and Release Thermal Energy Between 8 Degrees C and 16 Degrees C

(71) Applicant: Douglas Alan Ames, Huntington Beach, CA (US)

(72) Inventor: Douglas Alan Ames, Huntington Beach, CA (US)

(21) Appl. No.: 19/176,010

(22) Filed: Apr. 10, 2025

Related U.S. Application Data
(60) Provisional application No. 63/632,632, filed on Apr. 11, 2024.

(51) Int. Cl. C09K 5/06; C08J 3/205; C08K 3/16; C08K 3/30; C08K 3/34; C08K 3/38

(52) U.S. Cl. CPC C09K 5/063; C08J 3/2053; C08K 3/16; C08K 3/30; C08K 3/346; C08K 3/38; C08J 2333/02; C08K 2003/3045; C08K 2003/387; C08K 2201/014

(57) ABSTRACT

Eutectoid salt hydrate phase change material compositions for thermal energy storage are disclosed. A congruently melting, form-stabilized, homogenous salt hydrate phase change material includes both attapulgite clay and sodium polyacrylate, where the attapulgite clay functions as both a thixotropic dispersant during the mixing of the salt hydrate, and thereafter in concert with sodium polyacrylate in forming a permanent stabilizing matrix. In addition, in one preferred embodiment, a eutectoid salt hydrate is disclosed which changes phase between 11 degrees C. and 16 degrees C. and whose composition is one mol sodium sulfate decahydrate to 0.5 mols ammonium chloride to 0.22 moles potassium chloride. In a second preferred embodiment, a eutectoid salt hydrate is disclosed that changes phase between 8 degrees C. and 13 degrees C. and whose composition is one mol sodium sulfate decahydrate to 0.65 mols ammonium chloride to 0.22 mols potassium chloride.

### CROSS-REFERENCE TO RELATED APPLICATIONS

This application claims the benefit of U.S. Provisional Application No. 63/632,632, filed Apr. 11, 2024, the disclosure of which is hereby incorporated by reference in its entirety.

### STATEMENT REGARDING FEDERALLY SPONSORED RESEARCH OR DEVELOPMENT

Not applicable.

### REFERENCE TO A SEQUENCE TO A SEQUENCE LISTING, A LARGE TABLE, OR A COMPUTER PROGRAM LISTING APPENDIX ON READ-ONLY OPTICAL DISK.

Not applicable.

### BACKGROUND OF THE INVENTION

Building cooling systems account for a significant portion of total worldwide electricity consumption, highlighting the importance of focusing on these cooling systems to improve energy efficiency. In particular, U.S. data centers currently consume a substantial portion of the nation's electricity, with cooling systems for these data centers comprising a significant part of this energy usage. It has been estimated that data center load growth is projected to double or triple over the next decade.

Thermal energy storage (TES), in particular cool storage systems, reduce peak electric demand when integrated into chilled water cooling systems in buildings. Among several types of TES systems, salt hydrate phase change materials (PCMs) have been used in cool storage systems because of their high latent heat of fusion, low cost, non-flammability, and non-toxicity. However, without effective thickening or gelling agents, many salt hydrate PCMs experience phase separation and instability due to incongruent melting. This incongruent melting occurs after several cycles of heating and cooling and causes a portion of the PCM liquid to separate from the salt hydrate and form anhydrous salt, or salt crystals of lesser hydration, on the bottom of the container housing the salt hydrate PCM. This extent of this incongruent melting causes a corresponding loss of the available latent heat of fusion of the composition for TES.

To attempt to solve this problem of incongruent melting in salt hydrate PCMs, various thickeners have been used in the past, including silica gels, graphite, wood fiber, carboxymethyl cellulose (CMC), xantham gum, guar gum, or locust bean gum. Most recently, in U.S. Pat. No. 11,560,503 B2, dated Jan. 24, 2023, inventors from Oak Ridge National Labs were granted a patent entitled “Stable Salt Hydrate-Based Thermal Energy Storage Materials”. This patent discloses the use of polysaccharides, carbon nanofibers, and Dextran sulfate sodium salts as thickeners for salt hydrates. These gelling agents or thickeners often face issues such as failing to arrest incongruent melting after a number of cycles or high cost.

In 1976, Dr. Maria Telkes, famed inventor and pioneer in the fields of phase change materials and solar energy, was granted U.S. Pat. No. 3,986,969 for her invention entitled, “Thixotropic Thickener and Method of Making Same.” In this patent, Dr. Telkes disclosed attapulgite clay as an effective thickener for use with salt hydrate PCMs. Indeed, attapulgite clay has been used successfully as a dispersing agent and thickener in commercial salt hydrate PCM cool storage systems over thousands of freezing and melting cycles. However, it suffers from two principal drawbacks. First, with attapulgite clay alone as a thickener, the vertical depth of the salt hydrate in its container cannot exceed approximately 6.35 cm without phase separation caused by incongruent melting. Second, attapulgite clay alone does not prevent the formation of undesirable lesser hydrates which do not participate in the phase change at the intended temperatures. This drawback causes a diminution in the thermal energy storage capacity of the PCM, and thus a reduction in the capacity of the entire PCM storage system.

Sodium polyacrylate (SPA) has also been identified as a thickener for salt hydrate PCMS. When used alone as a thickener of salt hydrates, SPA provides a form-stabilized lattice matrix. However, during the mixing process, it is difficult to disperse the anhydrous salts evenly throughout to form a homogenous mixture. There have been continuing difficulties with the use of SPA alone, including manufacturing difficulties, with the salts tending to clump together at the bottom of mixing vat. Like with attapulgite clay, the use of SPA alone will not halt incongruent melting, and undesirable lesser hydrate crystal growth can occur over 10 to 20 cycles, resulting in reduced thermal storage capacity of the PCM storage system.

Hence, there remains a continued need for a stable, homogeneous, inexpensive salt hydrate hydrogel composition that will overcome incongruent melting and can be cycled through thousands of melting and freezing cycles while retaining its thermal storage capacity. There also remains a continued need for a manufacturing method to produce such a hydrogel.

Further, there is an ongoing need for stable, inexpensive salt hydrate PCMs that melt and freeze within a tight range to use with evaporative cooling technologies, particularly the cooling tower. One of the most studied and used salt hydrate PCMs is sodium sulfate decahydrate (SSD), which melts and freezes at 32° C. It is well known that by adding anhydrous salts to SSD, the phase change temperature range can be lowered.

In U.S. Pat. No. 4,689,164 dated Aug. 25, 1987, I disclosed a salt hydrate PCM which melts and freezes below 10° C., in the range of 5° C. to 9.5° C. This salt hydrate was based on sodium sulfate decahydrate (SSD), along with ammonium chloride and potassium chloride to reduce the temperature of the eutectoid salt hydrate. I referred to this salt hydrate PCM as a eutectoid, in that the mixture of the anhydrous salts with water produced a lower melting or freezing range than the constituents alone, but not necessarily the lowest phase change point or range of these constituents. I continue that definition in this application, so that the eutectoids disclosed herein are also considered to be salt hydrate PCMs.

A primary application for this 5° C. to 9.5° C. eutectoid PCM has been in buildings' chiller based liquid cooling systems. As disclosed in my U.S. Pat. No. 4,872,557 dated Oct. 10, 1989, this eutectoid was filled into nestable, stackable, permanently sealed containers. The salt hydrate filled containers were placed in a tank and the tank filled with water and piped into an existing or new chilled water-cooling loop for a building cooling system. The eutectic salt hydrate cool storage system shifted electricity consumption for the chillers from the daytime on-peak hours to nighttime off-peak hours, as well as allow the chillers to operate at increased efficiency resulting from cooler nighttime temperatures and increased loads.

In my U.S. Pat. No. 4,720,984 dated Jan. 16, 1988, I disclosed a further application for eutectoid PCMs based on evaporative cooling and not mechanical refrigeration. The eutectoid PCMs are charged, or frozen, with chilled water produced by the cooling towers, not the chillers. Then during the day, when ambient temperature conditions are far higher, the chillers are not operated, as in the conventional cool storage system, with the melting eutectoid PCMs providing cooling to the building. In this way, electricity consumption for cooling can be reduced by up to 80% by keeping the chillers off.

However, for the 5° C. to 9.5° C. eutectoid PCM disclosed in my U.S. Pat. No. 4,872,557, this chilled water temperature requirement of approximately 5° C. to freeze the this eutectoid is generally too low to achieve with chilled water produced from a cooling tower. Nevertheless, as noted in the 2025 American Society of Heating, Refrigeration, and Air Conditioning Engineers (ASHRAE) Technical Committee (TC) 9.9 “Datacom Encyclopedia”, chilled water temperature requirements for liquid cooling at data centers have been rising, with such chilled water supply temperature requirements now in the range of 18° C. to 20° C. This is due in part to the paucity of people in the data center and the resulting lack of dehumidification requirements in the central chilled water liquid cooling loop.

Further, in many traditional building cooling systems, especially in dry, hot areas, with large diurnal temperature swings, chilled water supply temperatures at 10° C. to 13° C. can sufficiently cool a commercial building. These slightly higher chilled water supply temperature requirements for buildings and data centers could be met with new eutectoid PCMs that melt and freeze within a range from 8° C. to 16° C. New eutectoids within this higher temperature range would be able to be charged for far longer periods of the year with water chilled by the cooling towers, not the chillers.

Thus, in addition to a need for a new thickening mixture for salt hydrate PCMs, there is a need for stable PCMs with high latent heats of fusion and low-cost that melt and freeze within the range of 8° C. to 16° C. Most preferably, there should be alternative eutectoid PCMs within this temperature range to allow for selection based on each building's chilled water supply temperature requirements and climatic conditions.

### BRIEF SUMMARY OF THE INVENTION.

Eutectoid salt hydrate phase change material compositions for thermal energy storage are disclosed. A congruently melting, form-stabilized, homogeneous salt hydrate PCM includes both attapulgite clay and SPA in the mixture, where the attapulgite clay functions as both a thixotropic dispersant in the mixing process and in concert with SPA in forming a stabilizing lattice matrix.

In a preferred embodiment, the method of preparation of these compositions includes initially mixing the attapulgite clay, at a concentration of 2% to 2.5% by weight of the total finished composition, into the full stoichiometric quantity of the water required for the salt hydrate. Thereafter, the anhydrous salts and other chemicals are added to the formulation. This procedure ensures that the attapulgite clay functions effectively as a thixotropic dispersant. The SPA, also at 2% to 2.5% by weight of the total composition, is added at the end of the mixing process to provide, along with the attapulgite clay, a form-stabilized gel that keeps the salts in suspension and largely prevents incongruent melting or the formation of undesirable lesser hydrates which reduce the thermal storage capacity of the eutectoid salt hydrate.

In addition, eutectoid salt hydrates that change phase within the range from 8° C. and 16° C. are disclosed which are comprised of SSD, ammonium chloride, and potassium chloride. In one preferred embodiment, a eutectoid that melts and freezes between 11° C. and 16° C. is comprised of one mol of sodium sulfate decahydrate, to 0.5 mols of ammonium chloride, and to 0.22 mols of potassium chloride. In another preferred embodiment, a eutectoid salt hydrate that melts and freezes between 8° C. and 13° C. is comprised of one mol of sodium sulfate decahydrate, to 0.65 mols of ammonium chloride, and to 0.22 mols of potassium chloride. These new salt hydrates have a heat of fusion over the indicated temperature ranges of approximately 105 J/gm.

### BRIEF DESCRIPTION OF THE SEVERAL VIEWS OF THE DRAWINGS

Not applicable.

### DETAILED DESCRIPTION OF THE INVENTION

The key to the use of a PCM for TES is its ability to be cycled, that is, frozen and melted through a phase change, thousands of times within a selected, relatively narrow temperature range while maintaining its thermal storage capacity. The disclosures herein provide such PCMs.

As noted above, Dr. Telkes' U.S. Pat. No. 3,986,969 disclosed the use of attapulgite clay as a dispersing agent and thickener for use with salt hydrates. As she stated in this patent at column 4: “In accordance with this invention, a clay-type thixotropic agent is used whose particles are lath-like in structure and which provide a high colloidal stability in the presence of salt solutions and other electrolytes. Clays of this type which are suitable for use with this invention are known as attapulgite, polygorskite or sepiolite.” As she noted in her patent and claims, her invention was intended to apply to all salt-hydrate PCMs, not just SSD.

As one current commercial seller of attapulgite clay, Active Minerals Corp., describes it: “Attapulgite is a 2:1 magnesium aluminum silicate clay. The attapulgite molecular formula is (Mg,Al)2Si₄O₁₀(OH)·4(H₂O). Attapulgite clay has a high surface area (150-320 m2/g), which is what gives it its desirable absorbent properties. At the microscopic level, the attapulgite structure is crystalline, with each individual crystal being in the shape of a rod. This rod-like structure differentiates attapulgite from other similar types of clay, such as bentonite, which is flatter and flakier in structure. Attapulgite clay mined in the U.S. has particles that are approximately 2.5 microns long or less and 25 nanometers wide, which makes attapulgite the ideal shape and size for forming a three-dimensional lattice structure for trapping liquids and other substances.” In addition, the thixotropic nature of this clay allows it to be used as a dispersant in the salt hydrate mixing process, ensuring a smooth homogenous mixture.

Attapulgite clay has been used as a dispersant and thickening agent in SSD-based eutectoid cool storage systems over thousands of cycles, with well over a decade of commercial operation while maintaining the salts in suspension and without degradation of the thermal storage capacity. Nevertheless, its use alone as a thickening agent imposes certain significant limitations. First, with attapulgite clay alone, to maintain the anhydrous salts in suspension, the vertical depth of the PCM composition should be limited to approximately no more than 6.35 cm. Should the vertical depth of the composition exceed this limit, incongruent melting and phase separation will result. Moreover, the attapulgite clay alone does not provide a form-stabilized, or gelatinous, structure when the eutectoid is in the liquid state, which adds to the incongruency problem. This 6.35 cm maximum depth imposes limits on the container design, manufacturing, and installation of the eutectic filled containers, as described in my U.S. Pat. No. 4,872,557 dated Oct. 10, 1989 entitled, “Nestable, Stackable Containers”.

A second problem with the use of attapulgite clay alone is that it allows for the formation of crystals which occur over the first twenty cycles. These crystals appear to be a lesser hydrate that have a phase change at around 22° C. and which appear to be sodium sulfate heptahydrate or a eutectoid thereof. These lesser hydrate crystals do not participate in the storage of thermal energy at the desired temperatures and thus reduce the PCM's thermal storage capacity. It is to be understood that the foregoing explanations are provided for explanatory purposes only and are not intended to limit the scope or validity of the claims.

More recently, SPA has been examined for use as a thickener or gelling agent in salt hydrate PCMs. SPA is a chemical polymer that is widely used in a variety of consumer products due to its ability to absorb several hundred times its mass in water. It is made up of multiple chains of acrylate compounds that possess a positive anionic charge, which attracts water-based molecules to combine with it, making SPA a suber-absorbent compound.

It is very difficult to use SPA alone as a thickener to create a homogeneous mixture. Only a portion of the salt solution is absorbed by and thickened by the SPA, with the rest remaining as a low viscosity liquid with uneven distribution of salts. In addition, the use of SPA alone as a thickener in salt hydrates suffers from the fact that the SPA lattice network still allows crystals of lesser hydrates to grow within it. When SPA is added at or near the beginning of the mixing process, a swollen matrix will be created. It is very difficult to add the anhydrous salts to this matrix in a homogeneous manner. Alternatively, when SPA is used alone and added at the end of the mixing process, after the salts and other solutions are mixed, some of the salts will be clumped together at the bottom of the mixing vat, and it is extremely difficult to disperse the salts homogeneously through the forming SPA lattice network.

I have discovered that there are substantial and unexpected synergistic benefits to the use of both attapulgite clay and SPA in a salt hydrate PCM to provide a homogeneous and congruently melting hydrogel. During the mixing process, the attapulgite clay powder is mixed into the water prior to the addition of anhydrous salts and functions as a low-viscosity liquid dispersant to ensure that the various salts added thereafter are homogeneously distributed throughout the formulation. Under the method disclosed herein, the SPA is added at the end of the mixing process, allowing for the dispersed, thixotropic salt hydrate liquid to be homogenously distributed throughout the newly forming lattice matrix. This new form-stabilized hydrogel will typically maintain suspension of the salts with approximately a 5″ vertical depth that maintains small crystal size and minimizes the growth of lesser hydrates.

The attapulgite clay and the SPA combine to provide a lattice network that holds the salts in suspension in a superior manner than either one alone. In this process, the swelling from the SPA is minimized, which is also advantageous to the PCM mixture by maintaining through the phase change the same lattice matrix, with the salts and hydrates trapped within the pockets of the matrix. The same crystal habit formation is maintained. The salt hydrate's form-stability further aids in prevention of leakage from the containers. Also, when used with water as the heat transfer medium, there is no need to add to the salt hydrate, from a heat-transfer perspective, a thermal conductivity enhancer such as graphite or metal shavings, as the salt hydrate can completely melt within four hours at normal operating temperatures.

While this hydrogel may be used with any salt hydrate PCM, one preferred embodiment characterizes the mixing process based on a eutectoid of SSD:

First, water at approximately 50° C. is poured into the mixing vat in a stoichiometric amount for SSD to achieve the total molar batch quantity desired.

Second, a surfactant such as sodium hexametaphosphate (SHMP) in a quantity of 0.25% by weight of the finished mixture, is dissolved into the water with agitation or mixing. The SHMP acts as a surfactant and dispersing agent.

Third, attapulgite clay powder is added in a quantity of approximately 2% to 2.5% of the weight of the finished mixture. This percentage will depend upon the concentration of the salts, with higher concentration compositions requiring a higher attapulgite clay concentration. The result is a low viscosity liquid with the clay fully dispersed.

Fourth, anhydrous sodium sulfate is added and mixed for at least 20 minutes. In this preferred embodiment, the molar quantity of the anhydrous sodium sulfate added is reduced by the molar quantity of sodium bisulfate employed as a pH reducer in the next step. The molar quantity of the anhydrous sodium sulfate is reduced by 2 to 2.5% and is replaced with the same molar quantity of sodium bisulfate. The added sodium bisulfate combines with sodium ions available from the sodium borate and SPA to complete the desired molar quantity of SSD. Mix thoroughly for 20 minutes.

Fifth, sodium bisulfate is added to reduce the pH to 6.5 or less in order to prevent ammonium ions from converting to ammonia gas. In this preferred embodiment, the molar quantity added by the NaHSO₄ is equivalent to 2 to 2.5% of the molar quantity of the SSD. Mix for ten minutes;

Sixth, ammonium chloride and potassium chloride are added in the desired stoichiometric amounts to achieve the required phase change range and allowed to mix in for at least 20 minutes;

Seventh, sodium borate decahydrate is added as a nucleating agent, in an amount equal to 3% to 3.5% by weight of the total weight of the batch and allowed to mix in for 20 minutes. At this point, the mixture continues to be in a thixotropic, fully dispersed, low viscosity liquid.

Eighth, and last, SPA is added in an amount of 2% to 2.5% of the gross weight of the batch. The SPA is allowed to mix in for at least 30 minutes. The mixture is poured into the container, pouch, or other implement and allowed to set up into a form-stabilized gel. From the above procedure, a strong, homogeneous, congruently melting salt hydrate PCM will result that will last through thousands of cycles.

In addition to the new salt hydrate stabilizing matrix described above, I have discovered low-cost, reliable eutectoid PCMs that melt and freeze within the range of 8° C. to 16° C.

In U.S. Pat. No. 4,689,164, I disclosed a eutectoid that melts and freezes in the range 5° C. to 9.5° C. The composition of that lower temperature salt hydrate is comprised of 4 mols of SSD, to 4 mols of ammonium chloride, to 1 mol of potassium chloride (4:4:1 molar ratio), which can be restated as 1 mol SSD; 0.5 mol NH₄Cl; 0.22 mol KCl (1:0.5:0.25), as well as sodium borate decahydrate as a nucleating agent and attapulgite clay as a thickener. This composition has a latent heat of fusion of approximately 95 J/g over this temperature range.

As preferred embodiments, I have invented two distinct salt hydrate PCMs that melt and freeze within the desired range of 8° C. to 16° C., based on SSD eutectoids which include ammonium chloride and potassium chloride. These two eutectoids are disclosed in the examples that follow.

### Example No. 1

### 1 Mol Na₂SO₄·10H₂O; 0.5 mols NH₄Cl; 0.22 mols KCl

### (Melting/Freezing Range: 11° C. to 16° C.)

In this first preferred embodiment of the composition designated herein as PCM No. 1, a eutectoid of SSD is identified which provides a phase change operating temperature range from 11° C. to 16° C. The composition of this eutectoid is as follows: For each mol of SSD, 0.50 mols of ammonium chloride (NH₄Cl), and 0.22 mols of potassium chloride (KCl) are added to the mixture. Attapulgite clay and SPA each constitute 2.0% by weight of the total weight of the finished composition. In addition, sodium bisulfate is added in a molar quantity equal to 2% of the molar quantity of sodium sulfate decahydrate, and the molar quantity of sodium sulfate to be added is reduced by this same amount. Sodium borate decahydrate also constitutes 3.0% by weight of the composition. The chemicals added to the mixture should be approximately 98% to 99% pure.

This PCM No.1 composition should be prepared according to the method of manufacturing detailed above to provide a latent heat of fusion of approximately 107 J/g over the PCM temperature range from 11° C. to 16° C. The PCM No.1 composition by weight is detailed Table 1 below.

TABLE 1
PCM No. 1 Composition By Weight

| Constituent | % of Composition By Weight |
|---|---|
| Water | 45.8 |
| SHMP | 0.2 |
| Attapulgite Clay | 2.0 |
| Sodium Sulfate | 34.3 |
| Sodium Bisulfate, 2.0 | 1.5 |
| Ammonium Chloride, 0.5 mols | 6.8 |
| Potassium Chloride, 0.22 mols | 4.4 |
| Sodium Borate Decahydrate | 3.0 |
| Sodium Polyacrylate | 2.0 |
| Total | 100% |

Moreover, PCM No. 1's temperature range and thermal storage capacity can be varied based on environmental conditions and available chilled water supply temperatures, as shown in Table 2 below:

TABLE 2
PCM No. 1 Thermal Storage Capacity
Over Different Temperature Ranges

| PCM No. 1 Temperature at | Thermal |
|---|---|
| Beginning of Melt Cycle | Storage |
| and Temperature Operating | Capacity |
| Range Over Melt Cycle | (J/g) |
| 12° C. (12° C.-16° C. range) | 96 |
| 11° C. (11° C.-16° C. range) | 107 |
| 10° C. (10° C.-16° C. range) | 111 |
| 8° C. (8° C.-16° C. range) | 118 |

This PCM No. 1 is best suited for data centers or other facilities where higher chilled water temperatures are acceptable. When used with the hydrogel and eutectoid compositions specified above, a congruently melting, form stabilized, and homogenous eutectoid will be provided that will last for thousands of melting and freezing cycles.

### Example No. 2

### 1 Mol Na₂SO_{4·}10H₂0; 0.65 mols NH₄Cl; 0.22 mols KCl

### (Melting/Freezing Range: 8° C. to 13° C.)

In this second preferred embodiment of the composition designated herein as PCM No. 2, a eutectoid of SSD is identified which provides an operating temperature range from 8° C. to 13° C. The composition of this eutectoid is as follows: For each mol of SSD, 0.65 mols of ammonium chloride (NH₄Cl), and 0.22 mols of potassium chloride (KCl) are added to the mixture. Attapulgite clay and SPA each constitute 2.5% by weight of the total weight of the finished composition. In addition, sodium bisulfate is added in a molar quantity equal to 2.5% of the molar quantity of sodium sulfate decahydrate, and the molar quantity of anhydrous sodium sulfate to be added to the mixture is reduced by this same 2.5% amount. Sodium borate decahydrate also constitutes 3.5% by weight of the composition. These slightly higher concentrations of additives for PCM No. 2 reflect the fact that the total weight of the anhydrous salts have increased compared to PCM No.1 and thus a stronger matrix and additives are required to keep the salts in suspension.

This PCM No.2 composition should be prepared according to the method of manufacturing detailed above to provide a latent heat of fusion of approximately 104 J/g over the PCM temperature range from 8° C. to 13° C. The PCM No. 2 composition by weight is detailed in Table 3 below.

[symbol]

[symbol]

[symbol]

TABLE 3
PCM No. 2 Composition By Weight

| Constituent | % of Composition By Weight |
|---|---|
| Water | 43.6 |
| SHMP | 0.2 |
| Attapulgite Clay | 2.5 |
| Sodium Sulfate | 33.5 |
| Sodium Bisulfate | 1.8 |
| Ammonium Chloride, .65 mols | 8.4 |
| Potassium Chloride, .22 mols | 4.0 |
| Sodium Borate Decahydrate | 3.5 |
| Sodium Polyacrylate | 2.5 |
| Total | 100% |

Moreover, PCM No. 2's temperature range and thermal storage capacity can be varied according to environmental conditions and available chilled water supply temperatures, as shown in Table 4 below:

TABLE 4
PCM No. 2 Thermal Storage Capacity
Over Different Temperature Ranges

| PCM No. 2 Temperature at | |
|---|---|
| Beginning of Melt Cycle | Thermal |
| and Temperature Operating | Storage |
| Range Over Melt Cycle: | Capacity |
| 9° C. (9° C.-13° C. range) | 94 J/g |
| 8° C. (8° C.-13° C. range) | 104 J/g |
| 7° C. (7° C.-13° C. range) | 110 J/g |
| 6° C. (6° C.-13° C. range) | 116 J/g |

PCM No. 2 is best suited for facilities where slightly lower chilled water supply temperatures, compared to PCM No.1, are required for building comfort. When used with the hydrogel and additives identified above, a congruently melting, form-stable, homogenous eutectoid will be provided that will last for thousands of melting and freezing cycles.

It is to be understood that the foregoing explanations of molecular, chemical, and crystallographic behavior are not intended to limit the scope or validity of the claims. The embodiments of the present inventions described above are intended to be merely exemplary and those skilled in the art shall be able to make variations and modifications without departing from the essence of the present invention. I wish to protect against obvious alternatives and modifications of my inventions by the present application, which is to be limited only by the scope of the following appended claims, including equivalents thereof.

I claim:

1. A salt hydrate phase change material composition adapted for the storage and release of thermal energy which includes both attapulgite clay and sodium polyacrylate, each in an amount greater than 0.1 percent and less than 15 percent by weight of the total weight of the composition.

2. A composition as claimed in claim 1, wherein attapulgite clay and sodium polyacrylate function in concert to provide a stabilizing matrix which maintains the salts in suspension and provides a congruently melting, form-stabilized, homogenous phase change material.

3. A composition as claimed in claim 1, wherein attapulgite clay constitutes by weight between 1 percent and 4 percent of the total weight of the composition.

4. A composition as claimed in claim 1, wherein sodium polyacrylate constitutes by weight between 1 percent and 4 percent of the total weight of the composition.

5. A composition as claimed in claim 1, wherein the salt hydrate is sodium sulfate decahydrate.

6. A composition as claimed in claim 5, wherein sodium borate decahydrate comprises between 1 percent and 5 percent by weight of the total weight of the composition.

7. A composition as claimed in claim 5, wherein sodium borate decahydrate acts as a nucleating agent.

8. A composition as claimed in claim 5, which also includes both ammonium chloride and potassium chloride.

9. A composition as claimed in claim 8, where the molar ratio of sodium sulfate to ammonium chloride is approximately 1:0.4 to 1:0.6 mols, and where the molar ratio of sodium sulfate to potassium chloride is approximately 1:0.15 to 1:0.30 mols.

10. A composition as claimed in claim 9 which melts and freezes in the range from 11° C. to 16° C. and provides approximately 107 J/g of thermal energy storage over this temperature range.

11. A composition as claimed in claim 8, where the molar ratio of sodium sulfate to ammonium chloride is approximately 1:0.6 to 1:0.7 mols, and where the molar ratio of sodium sulfate to potassium chloride is 1:0.15 to 1:0.30 mols.

12. A composition as claimed in claim 11 which melts and freezes in the range from 8° C. to 13° C. and provides approximately 104 J/g of thermal energy storage over this temperature range.

13. A method of manufacturing the composition as claimed in claim 1, wherein the attapulgite clay is thoroughly mixed into the full molar quantity of water required to produce the desired quantity of salt hydrate prior to the addition of anhydrous salts, and sodium polyacrylate is added last in the mixing process and allowed to thoroughly mix in to the composition.

14. A method of manufacturing the composition as claimed in claim 1, wherein the attapulgite clay, functioning as a thixotropic dispersant, is thoroughly mixed into the full molar quantity of water required to produce the desired quantity of salt hydrate prior to the addition of anhydrous salts; and the sodium polyacrylate, functioning as a thickener and gelling agent while acting in concert with attapulgite clay to form a lattice matrix, is added last to the mixture and allowed to thoroughly mix in to the mixture in order to enable the finished salt hydrate to provide a congruently melting, form-stabilized, homogeneous phase change material.

15. A salt hydrate phase change material composition adapted for the storage and release of thermal energy through the use of a eutectoid of sodium sulfate decahydrate, which composition accomplishes substantial thermal energy storage through the latent heat of fusion of the composition, where the molar ratio of sodium sulfate to ammonium chloride is approximately 1:0.4 to 1:0.6 mols, and where the molar ratio of sodium sulfate to potassium chloride is approximately 1:0.15 to 1:0.3 mols.

16. A salt hydrate composition as claimed in claim 15 which composition melts and freezes within a temperature range from 11° C. to 16° C. and where its latent heat of fusion is approximately 107 J/g over this temperature range.

17. A salt hydrate phase change material composition adapted for the storage and release of thermal energy through the use of a eutectoid of sodium sulfate decahydrate, which composition accomplishes substantial thermal energy storage through the latent heat of fusion of the composition, where the molar ratio of sodium sulfate to ammonium chloride is approximately 1:0.6 to 1:0.7 mols and where the molar ratio of sodium sulfate to potassium chloride is approximately 1:0.15 to 1:0.3 mols.

18. A salt hydrate composition as claimed in claim 17 which composition melts and freezes within a temperature range from approximately 8° C. to 13° C. and where its latent heat of fusion is approximately 104 J/g over this temperature range.

19. A method of manufacturing the compositions as claimed in claim 17, wherein sodium bisulfate is added in a molar quantity equal to 1 to 3% of the molar quantity of sodium sulfate decahydrate, and where the molar quantity of sodium sulfate is reduced by the same amount.

20. A method of manufacturing the composition as claimed in claim 17, wherein the molar quantity of anhydrous sodium sulfate added to the mixture is reduced by the molar quantity of the sodium bisulfate added to the mixture in order to lower the pH below 6.5 and keep the ammonium ions in suspension from converting to ammonia gas.
